(19) United States
(12) Patent Application Publication
(10) Pub. No.: US 2025/0042269 A1
(43) Pub. Date: Feb. 6, 2025

(54) POWER CONTROL APPARATUS FOR FUEL CELL VEHICLE, POWER CONTROL METHOD THEREOF, AND POWER SYSTEM FOR FUEL CELL VEHICLE INCLUDING THE POWER CONTROL APPARATUS

(71) Applicants: Hyundai Motor Company, Seoul (KR); Kia Corporation, Seoul (KR)

(72) Inventors: Beom Sik Kim, Gwangmyeong-si (KR); Kyu Won Jeong, Hwaseong-si (KR); Tae Woo Kim, Anyang-si (KR); Jae Hun Jeong, Anyang-si (KR); Mun Soo Chung, Uiwang-si (KR); Sang Don Lee, Suwon-si (KR)

(21) Appl. No.: 18/505,677

(22) Filed: Nov. 9, 2023

(30) Foreign Application Priority Data
Aug. 4, 2023 (KR) 10-2023-0102183

(51) Int. Cl. B60L 50/70; B60L 53/20; B60L 58/30

(52) U.S. Cl. CPC B60L 50/70; B60L 53/20; B60L 58/30

(57) ABSTRACT

An embodiment power control apparatus for a fuel cell vehicle includes a first relay connected to a fuel cell stack, a second relay selectively connected to an external charger, a converter connected to the first relay and the second relay, wherein the converter is configured to convert first electric power input thereto via the first relay into first demand electric power, convert second electric power input thereto via the second relay into second demand electric power, and supply the first demand electric power or the second demand electric power to a power consumption device, and a controller configured to control the first relay, the second relay, and the converter.

### CROSS-REFERENCE TO RELATED APPLICATIONS

This application claims the benefit of Korean Patent Application No. 10-2023-0102183, filed on Aug. 4, 2023, which application is hereby incorporated herein by reference.

### TECHNICAL FIELD

The present invention relates to power control for a fuel cell vehicle, a power control method thereof, and a power system for a fuel cell vehicle including the power control apparatus.

### BACKGROUND

Hydrogen fuel cell vehicles, which are currently mass-produced, use a hydrogen fuel cell and a high-voltage battery as a power source. In such a hydrogen fuel cell vehicle, energy produced by the hydrogen fuel cell is boosted using a fuel cell DC-DC converter disposed between the hydrogen fuel cell and the high-voltage battery, and the boosted energy is then supplied to a motor system or is used to charge the high-voltage battery.

Excessive use of the high-voltage battery may cause failure of electric vehicle (EV) driving or initial fuel cell ignition using the high-voltage battery and, as such, failure of vehicle driving may occur.

In order to prevent failure of vehicle driving, which may occur due to shortage of energy in the high-voltage battery, it is necessary to stably maintain a state of charge (SOC) of the high-voltage battery through additional charging of the high-voltage battery.

Therefore, a large volume of research for stable maintenance of an SOC of a high-voltage battery for a fuel cell vehicle is required.

The background art described as above is technical information possessed by the inventors of embodiments of the present invention to devise embodiments of the present invention or obtained during the step of devising embodiments of the present invention and may not necessarily be regarded as the known art disclosed to the public before filing of the application.

### SUMMARY

The present invention relates to power control for a fuel cell vehicle, a power control method thereof, and a power system for a fuel cell vehicle including the power control apparatus. Particular embodiments relate to a power control apparatus for a fuel cell vehicle capable of charging a high-voltage battery using a fuel cell stack and an external charger, a power control method thereof, and a power system for a fuel cell vehicle including the power control apparatus.

Therefore, embodiments of the present invention have been made in view of problems in the art, and an embodiment of the present invention provides a power control apparatus for a fuel cell vehicle capable of charging a high-voltage battery using a fuel cell stack, a power control method thereof, and a power system for a fuel cell vehicle including the power control apparatus.

Another embodiment of the present invention provides a power control apparatus for a fuel cell vehicle capable of charging a high-voltage battery using an external charger (for example, a fast charger), a power control method thereof, and a power system for a fuel cell vehicle including the power control apparatus.

Another embodiment of the present invention provides a power control apparatus for a fuel cell vehicle capable of charging a high-voltage battery using a fuel cell stack and an external charger, a power control method thereof, and a power system for a fuel cell vehicle including the power control apparatus.

Another embodiment of the present invention provides a power control apparatus for a fuel cell vehicle capable of charging a high-voltage battery using a fuel cell stack and an external charger without addition of a separate power converter, a power control method thereof, and a power system for a fuel cell vehicle including the power control apparatus.

Embodiments of the present invention are not limited to the above-described embodiments, and other embodiments of the present invention not yet described will be more clearly understood by those skilled in the art from the following detailed description.

In accordance with an embodiment of the present invention, the above and other features can be accomplished by the provision of a power control apparatus for a fuel cell vehicle capable of charging a high-voltage battery using a fuel cell stack and an external charger, a power control method thereof, and a power system for a fuel cell vehicle including the power control apparatus.

In one embodiment of the present invention, there is provided a power control apparatus for a fuel cell vehicle including a first relay connected to a fuel cell stack, a second relay selectively connected to an external charger, a converter connected to the first relay and the second relay, and a controller configured to control the first relay, the second relay, and the converter.

In accordance with an embodiment, the converter may convert first electric power input thereto via the first relay into first demand electric power, may convert second electric power input thereto via the second relay into second demand electric power, and may then supply the first demand electric power and the second demand electric power to a power consumption device.

In accordance with an embodiment, the second relay may turn off when the first relay turns on, and the second relay may turn on when the first relay turns off, thereby causing the first electric power and the second electric power not to be simultaneously input to the converter.

In accordance with an embodiment, the controller may turn on the first relay, may turn off the second relay, and may control the converter to convert the first electric power into the first demand electric power.

In accordance with an embodiment, the controller may turn off the first relay, may turn on the second relay, and may control the converter to convert the second electric power into the second demand electric power.

In accordance with an embodiment, the converter may supply the first demand electric power to a high-voltage battery and a motor system.

In accordance with an embodiment, the converter may supply the second demand electric power to a high-voltage battery.

In accordance with an embodiment, the controller may turn off the first relay and may turn on the second relay upon determining that a current state is a vehicle ignition off state and a current mode is a fast charging mode, based on vehicle-associated information input thereto from an outside thereof.

In accordance with an embodiment, the controller may turn on the first relay and may turn off the second relay upon determining that a current state is a vehicle ignition on state and a current mode is a fuel cell electric vehicle (FCEV) mode, based on vehicle-associated information input thereto from an outside thereof.

In accordance with an embodiment, the controller may control the converter not to be driven upon determining that a current state is a vehicle ignition on state and a current mode is not a fuel cell electric vehicle (FCEV) mode, based on vehicle-associated information input thereto from an outside thereof.

In another embodiment of the present invention, there is provided a power control method for a fuel cell vehicle including converting, by a converter, first electric power input to the converter via a first relay connected to a fuel cell stack into first demand electric power, converting, by the converter, second electric power input to the converter via a second relay selectively connected to an external charger into second demand electric power, and supplying, by the converter, one of the first demand electric power and the second demand electric power to a power consumption device.

In accordance with an embodiment, converting the first electric power into the first demand electric power may include turning on the first relay by the controller, turning off the second relay by the controller, and controlling the converter to convert the first electric power into the first demand electric power by the controller.

In accordance with an embodiment, converting the second electric power into the second demand electric power may include turning off the first relay by the controller, turning on the second relay by the controller, and controlling the converter to convert the second electric power into the second demand electric power by the controller.

In accordance with an embodiment, the supplying may include supplying the first demand electric power to a high-voltage battery and a motor system.

In accordance with an embodiment, the supplying may include supplying the second demand electric power to a high-voltage battery.

In accordance with an embodiment, the power control method may further include determining, by the controller, control for the first relay, the second relay, and the converter, based on vehicle-associated information input to the controller from an outside thereof.

In accordance with an embodiment, the determining may include turning on the first relay and turning off the second relay upon determining that a current state is a vehicle ignition on state and a current mode is a fuel cell electric vehicle (FCEV) mode.

In accordance with an embodiment, the determining may include turning off the first relay and turning on the second relay upon determining that a current state is a vehicle ignition off state and a current mode is a fast charging mode.

In accordance with an embodiment, the determining may include controlling the converter not to be driven upon determining that a current state is a vehicle ignition on state and a current mode is not a fuel cell electric vehicle (FCEV) mode.

In another embodiment of the present invention, there is provided a power control system for a fuel cell vehicle including a power control apparatus including a first relay, a second relay, a converter connected to one end of each of the first and second relays, and a controller, a fuel cell stack connected to another end of the first relay, an external charger selectively connected to another end of the second relay, and a high-voltage battery configured to receive electric power output from the converter.

In accordance with an embodiment, the converter may convert first electric power input thereto via the first relay into first demand electric power, may convert second electric power input thereto via the second relay into second demand electric power, and may then supply the first demand electric power and the second demand electric power to a power consumption device.

Detailed matters according to various embodiments of the present invention, except for the solutions to the problems as described above, are included in the following description and the accompanying drawings.

The problems to be solved and the solutions to the problems as described above are not to be construed as essential features of the claims. Accordingly, the scope of the claims is not limited by the matters described in the content of the present application.

### BRIEF DESCRIPTION OF THE DRAWINGS

The above and other objects, features, and other advantages of embodiments of the present invention will be more clearly understood from the following detailed description taken in conjunction with the accompanying drawings, in which:

FIG. 1 is a diagram showing a configuration of a power system for a fuel cell vehicle according to an embodiment of the present invention;

FIG. 2 is a diagram showing a detailed configuration of a converter of a power control apparatus for a fuel cell vehicle according to an embodiment of the present invention;

FIG. 3 is a diagram showing a detailed configuration of a controller of the power control apparatus for the fuel cell vehicle according to an embodiment of the present invention;

FIG. 4 is a diagram depicting states of first and second relays according to control of a control signal output circuit in an embodiment of the present invention; and

FIG. 5 is a flowchart explaining a power control method for a fuel cell vehicle according to an embodiment of the present invention.

### DETAILED DESCRIPTION OF ILLUSTRATIVE EMBODIMENTS

The advantages, features, and methods of achieving the same of embodiments of the present invention will be more clearly understood from the following detailed description taken in conjunction with the accompanying drawings. However, the embodiments of the present invention are not limited to a variety of embodiments described below and can be implemented in various forms. The exemplary embodiments of the present invention are provided only to completely disclose embodiments of the present invention and fully inform a person having ordinary knowledge in the field to which the present invention pertains of the scope of the present invention. Accordingly, embodiments of the present invention are defined by the scope of the claims.

The shape, size, ratio, angle, number and the like shown in the drawings to illustrate the embodiments of the present invention are only for illustration and are not limited to the contents shown in the drawings. Wherever possible, the same reference numerals will be used throughout the drawings to refer to the same or like parts. In the following description, detailed descriptions of technologies or configurations related to embodiments of the present invention may be omitted so as not to unnecessarily obscure the subject matter of embodiments of the present invention. When terms such as “including”, “having”, and “comprising” are used throughout the specification, an additional component may be present, unless “only” is used. A component described in a singular form encompasses components in a plural form unless particularly stated otherwise.

It should be interpreted that the components included in the embodiments of the present invention include an error range, although there is no additional particular description thereof.

In describing a variety of embodiments of the present invention, when a temporal relationship is described, for example, when terms for a temporal relationship of events such as “after”, “subsequently”, “next”, and “before” are used, there may also be the case in which the events are not continuous, unless “immediately” or “directly” is used.

In the meantime, although terms including an ordinal number, such as first or second, may be used to describe a variety of constituent elements, the constituent elements are not limited to the terms, and the terms are used only for the purpose of discriminating one constituent element from other constituent elements. Accordingly, a first constituent element described hereinafter may be named a second constituent element.

It will be understood that, although the terms first, second, A, B, (a), (b), etc. may be used herein to describe various elements of embodiments of the present invention, these terms are only used to distinguish one element from another element and necessity, order, sequence of corresponding elements, numbers, etc. are not limited by these terms. It will be understood that, when one element is referred to as being “connected to”, “coupled to”, or “accessed by” another element, one element may be “connected to”, “coupled to”, or “accessed by” another element via a further element although one element may be directly connected to or directly accessed by another element.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item.

The following embodiments may be partially or overall coupled or combined and may be technically linked and implemented in various manners. The embodiments may be independently implemented or may be implemented in a co-dependent relationship.

Hereinafter, embodiments of the present invention will be described with reference to the accompanying drawings. In addition, the dimension scales of constituent elements shown in the drawings may be different from actual dimension scales, for convenience of description. That is, the dimension scales of constituent elements shown in the drawings should not be interpreted to be the same as those shown in the drawings.

Hereinafter, a power control apparatus for a fuel cell vehicle according to an embodiment of the present invention, a power control method thereof, and a power system for a fuel cell vehicle including the power control apparatus will be described with reference to the accompanying drawings.

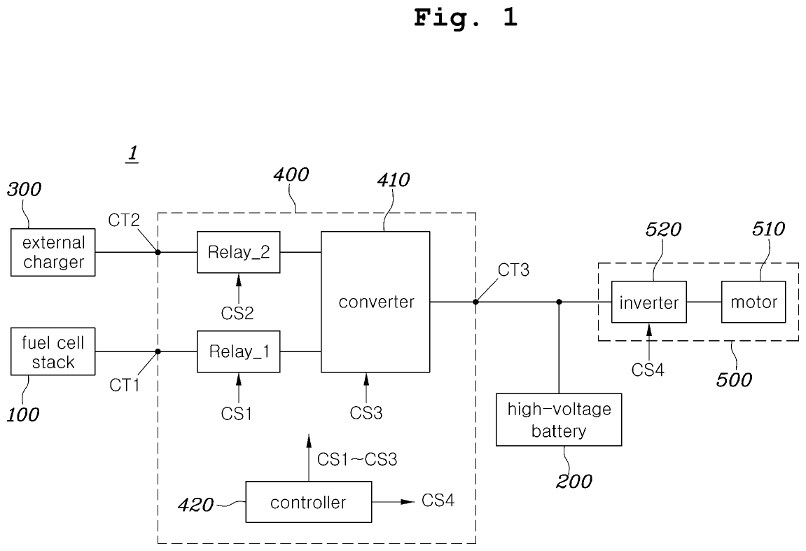

FIG. 1 is a diagram showing a configuration of a power system 1 for a fuel cell vehicle according to an embodiment of the present invention.

Referring to FIG. 1, the power system 1 according to the embodiment of the present invention may include a fuel cell stack 100, a high-voltage battery 200, an external charger 300, a power control apparatus 400, and a motor system 500.

In accordance with an embodiment, the fuel cell stack 100 (or a first energy storage device or a first energy supplier) may produce and output first electric power (or first electrical energy) through chemical reaction between oxygen and hydrogen.

The first electric power output from the fuel cell stack 100 may be supplied to the motor system 500 or the high-voltage battery 200 by the power control apparatus 400.

That is, the first electric power output from the fuel cell stack 100 may be used to drive a motor 510 or may be used to charge the high-voltage battery 200.

For example, a fuel cell of the fuel cell stack 100 may be a polymer electrolyte membrane fuel cell (PEMFC) or a proton exchange membrane fuel cell (PEMFC), without being limited thereto.

In accordance with an embodiment, the high-voltage battery 200 (or a second energy storage device or a second energy supplier) may supply second electric power (or second electrical energy).

The high-voltage battery 200 may be charged by the first electric power supplied from the power control apparatus 400. In addition, the high-voltage battery 200 may receive third electric power (or third electrical energy) output from the external charger 300 through the power control apparatus 400 and may be charged with the third electric power.

The second electric power supplied from the high-voltage battery 200 may be supplied to the fuel cell stack 100 by the power control apparatus 400 and, as such, may be used for ignition (or driving) of the fuel cell stack 100.

In accordance with an embodiment, the external charger 300 (or a third energy storage device or a third energy supplier) is an energy supply source installed outside the fuel cell vehicle without being mounted in the fuel cell vehicle. For example, the external charger 300 may be a fast charger (or a high-speed charger).

When the external charger 300 is connected to the power control apparatus 400, the external charger 300 may be included in the power system 1 for the fuel cell vehicle according to an embodiment of the present invention and, as such, may supply the third electric power (or the third electrical energy) to the side of the power control apparatus 400.

The third electric power supplied from the external charger 300 may be supplied to the high-voltage battery 200 through the power control apparatus 400. That is, the third electric power supplied from the external charger 300 may be used to charge the high-voltage battery 200.

In accordance with an embodiment, the power control apparatus 400 may perform processing for electric power in the fuel cell vehicle.

If necessary, the power control apparatus 400 may appropriately convert electric power (or electrical energy) input thereto from an outside thereof. The power control apparatus 400 may distribute input electric power and may then transfer the distributed electric power to other configurations in the fuel cell vehicle.

In accordance with an embodiment, the power control apparatus 400 may receive the first electric power supplied from the fuel cell stack 100 and may supply the received first electric power to the high-voltage battery 200 to charge the high-voltage battery 200, or the power control apparatus 400 may supply the received first electric power to the motor system 500 to drive the motor system 500.

In accordance with an embodiment, the power control apparatus 400 may receive the second electric power supplied from the high-voltage battery 200 and may supply the received second electric power to the fuel cell stack 100 to operate the fuel cell stack 100.

In accordance with an embodiment, the power control apparatus 400 may receive the third electric power supplied from the external charger 300 and may supply the received third electric power to the high-voltage battery 200 to charge the high-voltage battery 200.

For example, the power control apparatus 400 may be connected to the fuel cell stack 100 via a first connection terminal CT1 (or a fuel cell connection terminal) and may be connected to the external charger 300 via a second connection terminal CT2 (or a charger connection terminal).

In accordance with an embodiment, the power control apparatus 400 may include a first relay (Relay_1) R_1, a second relay (Relay_2) R_2, a converter 410, and a controller 420.

The first relay R_1 may be disposed at the side of a first input of the converter 410 and may be disposed between the fuel cell stack 100 and the converter 410. For example, the first relay R_1 may be disposed between the converter 410 and the first connection terminal CT1. Accordingly, one end of the first relay R_1 may be connected to the converter 410, and the other end of the first relay R_1 may be connected to the fuel cell stack 100 while being connected to the first connection terminal CT1.

The first relay R_1 may be turned on or off under control of the controller 420 and may selectively interconnect the fuel cell stack 100 and the converter 410 in response to a first control signal CS1 of the controller 420.

The second relay R_2 may be disposed at the side of a second input of the converter 410 and may be disposed between the external charger 300 and the converter 410. For example, the second relay R_2 may be disposed between the converter 410 and the second connection terminal CT2. Accordingly, one end of the second relay R_2 may be connected to the converter 410, and the other end of the second relay R_2 may be selectively connected to the external charger 300 while being connected to the second connection terminal CT2.

The second relay R_2 may be turned on or off under control of the controller 420 and may selectively interconnect the external charger 300 and the converter 410 in response to a second control signal CS2 of the controller 420.

The converter 410 may operate in response to a third control signal CS3 and, as such, may convert electric power input thereto into demand electric power and may then output the demand electric power.

In accordance with an embodiment, the converter 410 may be a fuel cell DC-DC converter (FDC) (or a high-voltage boosting DC-DC converter).

In response to control of the controller 420, the converter 410 may convert the first electric power input to a first input thereof into first demand electric power and may then output the first demand electric power. The first demand electric power may be supplied to the high-voltage battery 200 or the motor system 500 via a third connection terminal CT3.

In this case, the converter 410 may receive the first electric power output from the fuel cell stack 100 via the first relay R_1. The first demand electric power may be electric power for driving the motor 510.

In response to control of the controller 420, the converter 410 may convert the second electric power supplied from the high-voltage battery 200 into second demand electric power and may then output the second demand electric power. The second demand electric power may be supplied to the fuel cell stack 100.

In this case, the second demand electric power may be electric power required to drive the fuel cell stack 100.

In response to control of the controller 420, the converter 410 may convert the third electric power input to a second input thereof into third demand electric power, and may then output the third demand electric power. The third demand electric power may be supplied to the high-voltage battery 200.

In this case, the converter 410 may receive the third electric power output from the external charger 300 via the second relay R_2. The third demand electric power may be electric power for charging the high-voltage battery 200.

The controller 420 may control overall operations of the power control apparatus 400 and may control the first relay R_1, the second relay R_2, and the converter 410, thereby enabling the converter 410 to supply demand electric power to a power consumption device.

For example, the controller 420 may control the first relay R_1, the second relay R_2, and the converter 410 based on vehicle ignition on/off state information and vehicle mode information input thereto from an outside thereof.

In accordance with an embodiment, the controller 420 may output a fourth control signal CS4 for controlling operation of an inverter 520 of the motor system 500.

In accordance with an embodiment, the motor system 500 may drive a motor using electric power supplied from the power control apparatus 400.

For example, the motor system 500 may include a motor 510 and the inverter 520, which phase-converts electric power supplied from the power control apparatus 400 into electric power required for driving of the motor 510, thereby driving the motor 510.

In accordance with an embodiment, the inverter 520 may convert a voltage input thereto from the power control apparatus 400 into a 3-phase AC voltage through a semiconductor switching element based on a fourth control signal CS4 applied from the controller 420, thereby driving the motor 510.

In accordance with the embodiment of the present invention as described above, it may be possible to not only charge the high-voltage battery 200 using the fuel cell stack 100 but also to charge the high-voltage battery 200 using the external charger 300.

In addition, all of driving (or ignition) of the fuel cell stack 100, charging of the high-voltage battery 200 using the fuel cell stack 100, charging of the high-voltage battery 200 using the external charger 300, and power supply to the motor system 500 may be achieved by one power control apparatus 400.

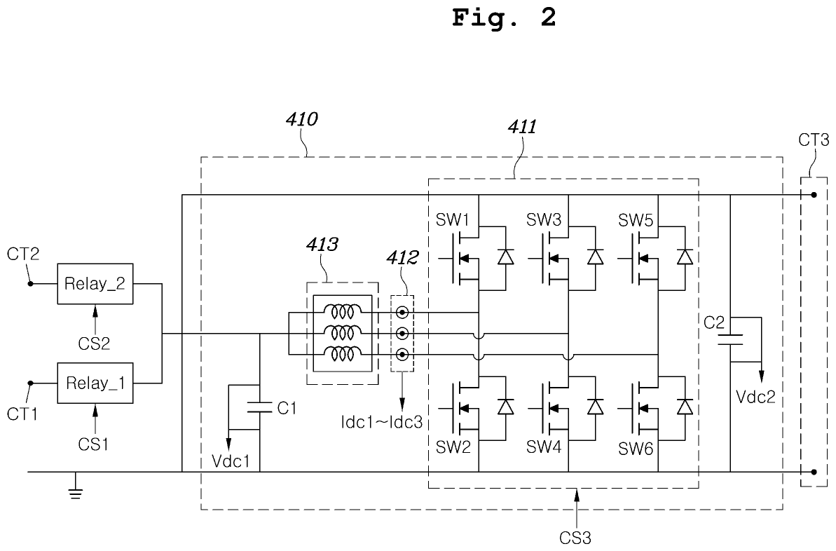

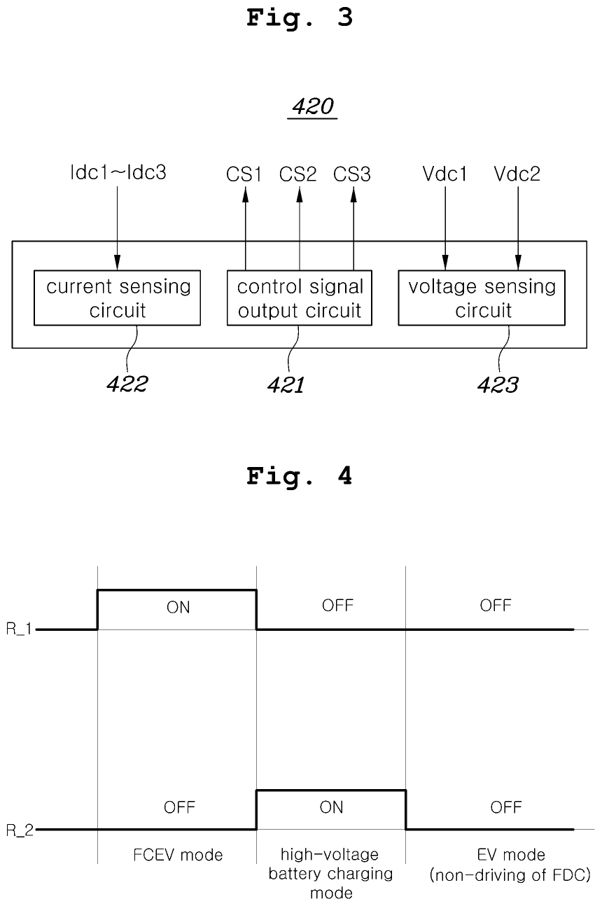

FIG. 2 is a diagram showing a detailed configuration of the converter 410 of the power control apparatus 400 for the fuel cell vehicle according to an embodiment of the present invention. FIG. 3 is a diagram showing a detailed configuration of the controller 420 of the power control apparatus 400 for the fuel cell vehicle according to an embodiment of the present invention.

Hereinafter, the power control apparatus 400 for the fuel cell vehicle according to an embodiment of the present invention will be described with reference to FIGS. 1 to 3.

In accordance with an embodiment of the present invention, the converter 410 may include a power conversion module 411, a current sensor unit 412, a coil unit 413, a first capacitor C1, and a second capacitor C2, without being limited thereto.

In accordance with an embodiment of the present invention, the controller 420 may include a control signal output circuit 421, a current sensing circuit 422, and a voltage sensing circuit 423, without being limited thereto.

The power conversion module 411 may include a plurality of switching elements SW1 to SW6 configured to perform switching in accordance with a third control signal CS3 output from the control signal output circuit 421.

For example, the third control signal CS3 may include a plurality of pulse width modulation (PWM) signals PWM1 to PWM6 for controlling the plurality of switching elements SW1 to SW6, respectively.

For example, each of the plurality of switching elements SW1 to SW6 included in the power conversion module 411 may be an insulated gate bipolar transistor (IGBT) or a silicon carbide-field effect transistor (SiC-FET).

The power conversion module 411 may convert electric power input thereto into demand electric power in accordance with the control signal CS3 of the control signal output circuit 421 and may then output the demand electric power.

The first capacitor C1 may be connected in parallel to each of the fuel cell stack 100 and the power conversion module 411 between the fuel cell stack 100 and the power conversion module 411. For example, the first capacitor C1 may be connected in parallel to each of the first relay R_1 and the power conversion module 411 between the first relay R_1 and the power conversion module 411.

One end of the first capacitor C1 may be connected between the first relay R_1 and the power conversion module 411, and the other end of the first capacitor C1 may be connected to the ground.

The first capacitor C1 may filter out a ripple component of a DC voltage input to the power conversion module 411 and, as such, may prevent a ripple component from being input to the power conversion module 411.

In addition, the first capacitor C1 may filter out a ripple component of a DC voltage supplied to the fuel cell stack 100 after being output from the power conversion module 411 and, as such, may prevent the ripple component from being input to the fuel cell stack 100.

The second capacitor C2 may be connected in parallel to each of the power conversion module 411 and the high-voltage battery 200 between the power conversion module 411 and the high-voltage battery 200.

One end of the second capacitor C2 may be connected between the power conversion module 411 and the high-voltage battery 200, and the other end of the second capacitor C2 may be connected to the ground.

The second capacitor C2 may filter out a ripple component of a DC voltage input to the high-voltage battery 200 after being output from the power conversion module 411 and, as such, may prevent the ripple component from being input to the high-voltage battery 200.

The current sensor unit 412 may be disposed at the side of the fuel cell stack 100 of the power conversion module 411 to measure DC currents Idc1 to Idc3 input to the power conversion module 411. For example, the current sensor unit 412 may be disposed between the first relay R_1 and the power conversion module 411.

The coil unit 413 may be disposed at the side of the fuel cell stack 100 of the power conversion module 411. For example, the coil unit 413 may be disposed in series between the first relay R_1 and the power conversion module 411. For example, the coil unit 413 may form a filter unit together with the first capacitor C1.

The control signal output circuit 421 may control the first relay R_1, the second relay R_2, and the power conversion module 411 of the converter 410 based on vehicle ignition on/off state information and vehicle mode information input thereto from an outside thereof.

In accordance with an embodiment, in a vehicle ignition off state IG OFF and a fast charging mode, the control signal output circuit 421 may turn off the first relay R_1 while turning on the second relay R_2.

In addition, the control signal output circuit 421 may control the power conversion module 411 in order to convert electric power input through the second relay R_2 into electric power for high-voltage battery charging.

Accordingly, electric power of the external charger 300 input through the second relay R_2 may be supplied to the high-voltage battery 200.

In accordance with an embodiment, in a vehicle ignition on state IG ON and a fuel cell electric vehicle (FCEV) mode, the control signal output circuit 421 may turn on the first relay R_1 while turning off the second relay R_2.

In addition, the control signal output circuit 421 may convert electric power of the high-voltage battery 200 into electric power for fuel cell stack ignition through control for the power conversion module 411 and may then supply the converted electric power to the fuel cell stack 100 for ignition of the fuel cell stack 100 (FDC buck mode).

Thereafter, the control signal output circuit 421 may convert electric power output from the fuel cell stack 100 into electric power for motor driving through control for the power conversion module 411.

In addition, the control signal output circuit 421 may convert the electric power for motor driving into electric power for driving of a 3-phase motor by controlling the inverter 520 of the motor system 500.

Accordingly, the electric power of the fuel cell stack 100 input through the first relay R_1 may be supplied to the motor system 500 (the FCEV mode) and, as such, may charge the high-voltage battery 200 connected in parallel between the converter 410 and the motor system 500.

In accordance with an embodiment, the control signal output circuit 421 does not perform control for the converter 410 in the vehicle ignition on state IG ON and not in the FCEV mode (that is, an EV mode).

For example, the control signal output circuit 421 may turn off both the first and second relays R_1 and R_2 and may not output the control signal CS3 to the power conversion module 411.

FIG. 4 is a diagram depicting states of the first and second relays R_1 and R_2 according to control of the control signal output circuit 421 in an embodiment of the present invention.

As shown in FIG. 4, the first and second relays R_1 and R_2 may be maintained in different states, respectively, when the vehicle operates in the FCEV mode or in the high-voltage battery charging mode. On the other hand, when the vehicle operates in the EV mode in which FDC driving is not required, the first and second relays R_1 and R_2 may be maintained in a turn-off state.

Since the second relay R_2 turns off when the first relay R_1 turns on, and the second relay R_2 turns on when the first relay R_1 turns off, electric power from the first relay R-1 and electric power from the second relay R_2 are not simultaneously input to the converter 410.

The current sensing circuit 422 may be connected to the current sensor unit 412 and, as such, may obtain DC currents Idc1 to Idc3 measured by the current sensor unit 412.

The voltage sensing circuit 423 may measure both ends of the first capacitor C1 and, as such, may obtain a low-voltage-side DC voltage Vdc1.

In addition, the voltage sensing circuit 423 may measure both ends of the second capacitor C2 and, as such, may obtain a high-voltage-side DC voltage Vdc2.

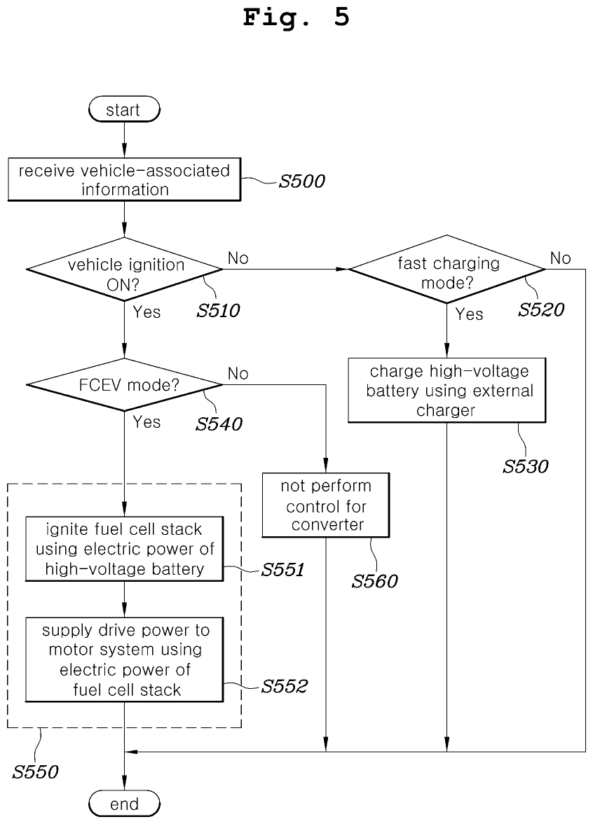

FIG. 5 is a flowchart explaining a power control method for a fuel cell vehicle according to an embodiment of the present invention.

Sequential operations shown in FIG. 5 may be carried out by the power control system 1 for the fuel cell vehicle described with reference to FIGS. 1 to 4.

Hereinafter, the power control method for the fuel cell vehicle according to an embodiment of the present invention will be described mainly in conjunction with operation of the power control apparatus 400 for the fuel cell vehicle.

First, the controller 420 may receive vehicle-associated information from an outside thereof (for example, a hybrid control unit) (S500).

In step S500, the vehicle-associated information may include vehicle ignition on/off state information and vehicle mode information.

The controller 420 may determine control for the first relay R_1, the second relay R_2, and the converter 410 based on the vehicle-associated information input from an outside thereof.

Thereafter, the controller 420 may determine whether or not a current state is a vehicle ignition on state based on the vehicle ignition on/off state information (S510).

Upon determining in step S510 that the current state is not the vehicle ignition on state (S510-No) or the current state is the vehicle ignition off state, the controller 420 may determine whether or not a current mode is a fast charging mode based on the vehicle mode information (S520).

Upon determining in step S520 that the current mode is not the fast charging mode (S520-No), the controller 420 may not perform control operation and may then end operation thereof.

Upon determining in step S520 that the current mode is the fast charging mode (S520-Yes), the controller 420 may charge the high-voltage battery 200 using electric power supplied from the external charger 300 connected to the second relay R_2 by controlling the first relay R_1, the second relay R_2, and the power conversion module 411 of the converter 410 (S530).

In step S530, the controller 420 may turn off the first relay R_1 connected to the fuel cell stack 100 and may turn on the second relay R_2 connected to the external charger 300.

In addition, the controller 420 may control the power conversion module 411 of the converter 410 in order to convert the electric power supplied from the external charger 300 into electric power for charging the high-voltage battery 200.

On the other hand, upon determining in step S510 that the current state is the vehicle ignition on state (S510-Yes), the controller 420 may determine whether or not the current mode is an FCEV mode based on the vehicle mode information (S540).

Upon determining in step S540 that the current mode is the FCEV mode (S540-Yes), the controller 420 may supply, to the motor system 500, electric power output from the fuel cell stack 100 connected to the first relay R_1 by controlling the first relay R_1, the second relay R_2, and the power conversion module 411 of the converter 410 (S550).

In step S550, the controller 420 may turn on the first relay R_1 connected to the fuel cell stack 100 and may turn off the second relay R_2.

In addition, the controller 420 may control the power conversion module 411 of the converter 410 to convert electric power of the high-voltage battery 200 into electric power for ignition of the fuel cell stack 100 and then to supply the converted electric power to the fuel cell stack 100 (S551). Accordingly, the fuel cell stack 100 may perform ignition based on the electric power for fuel cell stack ignition.

After ignition of the fuel cell stack 100, the controller 420 may control the power conversion module 411 of the converter 410 to convert electric power output from the fuel cell stack 100 into electric power for motor driving and then to supply the converted electric power to the motor system 500 (S552). Accordingly, the motor 510 may be driven based on the electric power for motor driving.

In this case, the controller 420 may control the inverter 520 of the motor system 500 in addition to the power conversion module 411 of the converter 410. In accordance with control of the controller 420, the inverter 520 may convert a voltage input thereto from the power conversion module 411 into a 3-phase AC voltage in order to drive the motor 510.

Upon determining in step S540 that the current mode is not the FCEV mode (S540-No), the controller may not perform control for the converter 410 and, as such, the converter 410 may not be driven (S560).

In accordance with an embodiment of the present invention, it may be possible to provide a power control apparatus for a fuel cell vehicle capable of charging a high-voltage battery using a fuel cell stack, a power control method thereof, and a power system for a fuel cell vehicle including the power control apparatus.

In accordance with another embodiment of the present invention, it may be possible to provide a power control apparatus for a fuel cell vehicle capable of charging a high-voltage battery using an external charger (for example, a fast charger), a power control method thereof, and a power system for a fuel cell vehicle including the power control apparatus.

In accordance with another embodiment of the present invention, it may be possible to provide a power control apparatus for a fuel cell vehicle capable of charging a high-voltage battery using a fuel cell stack and an external charger, a power control method thereof, and a power system for a fuel cell vehicle including the power control apparatus.

In accordance with another embodiment of the present invention, it may be possible to provide an FDC capable of achieving all of driving (or ignition) of a fuel cell stack, charging of a high-voltage battery using the fuel cell stack, charging of a high-voltage battery using an external charger, and supply of electric power to a motor system.

As the FDC, which is a power conversion device having multiple functions (or operations), is provided, it may be possible to achieve charging of the high-voltage battery using the fuel cell stack and charging of the high-voltage battery using the external charger without addition of a separate power converter, except for an existing FDC.

Accordingly, it may be possible to achieve charging of the high-voltage battery using the fuel cell stack and charging of the high-voltage battery using the external charger while reducing costs, as compared to the case in which individual power conversion devices should be provided for driving of the fuel cell stack and charging of the high-voltage battery, respectively.

In addition, it may be possible to achieve an enhancement in durability of the fuel cell stack and an enhancement in fuel economy of the fuel cell vehicle through cooperative control of the power control apparatus for the fuel cell vehicle and a fuel cell control unit (FCU) according to each of the embodiments of the present invention.

In a situation in which an infrastructure associated with a fast charger is expanded, it is expected that the power control apparatus for the fuel cell vehicle according to each of the embodiments of the present invention may be very usefully and effectively used in the fuel cell vehicle field.

Effects attainable in embodiments of the present invention are not limited to the above-described effects, and other effects of embodiments of the present invention not yet described will be more clearly understood by those skilled in the art from the appended claims.

Although embodiments of the present invention have been described in detail with reference to the accompanying drawings, the embodiments of the present invention are not limited to the embodiments and various changes may be made in the embodiments without departing from the principles and spirit of the invention. Therefore, the disclosed embodiments are to be considered in all respects as illustrative and not restrictive. The scope of the embodiments of the invention is indicated by the appended claims rather than the foregoing description, and all changes that come within the meaning and range of equivalency of the embodiments of the invention are intended to be embraced therein.

What is claimed is:

1. A power control apparatus for a fuel cell vehicle, the apparatus comprising:
a first relay connected to a fuel cell stack;
a second relay selectively connected to an external charger;
a converter connected to the first relay and the second relay, wherein the converter is configured to convert first electric power input thereto via the first relay into first demand electric power, convert second electric power input thereto via the second relay into second demand electric power, and supply the first demand electric power or the second demand electric power to a power consumption device; and
a controller configured to control the first relay, the second relay, and the converter.

2. The apparatus according to claim 1, wherein the second relay is configured to turn off when the first relay turns on and the second relay is configured to turn on when the first relay turns off such that the first electric power and the second electric power are not simultaneously input to the converter.

3. The apparatus according to claim 1, wherein the controller is configured to turn on the first relay, turn off the second relay, and control the converter to convert the first electric power into the first demand electric power.

4. The apparatus according to claim 1, wherein the controller is configured to turn off the first relay, turn on the second relay, and control the converter to convert the second electric power into the second demand electric power.

5. The apparatus according to claim 1, wherein the power consumption device comprises a high-voltage battery and a motor system, and wherein the converter is configured to supply the first demand electric power to the high-voltage battery and the motor system.

6. The apparatus according to claim 1, wherein the power consumption device comprises a high-voltage battery, and wherein the converter is configured to supply the second demand electric power to the high-voltage battery.

7. The apparatus according to claim 1, wherein the controller is configured to turn off the first relay and turn on the second relay based on a determination that a current state is a vehicle ignition off state and a current mode is a fast charging mode based on vehicle-associated information input to the controller from an outside thereof.

8. The apparatus according to claim 1, wherein the controller is configured to turn on the first relay and turn off the second relay based on a determination that a current state is a vehicle ignition on state and a current mode is a fuel cell electric vehicle (FCEV) mode based on vehicle-associated information input to the controller from an outside thereof.

9. The apparatus according to claim 1, wherein the controller is configured to control the converter not to be driven based on a determination that a current state is a vehicle ignition on state and a current mode is not a fuel cell electric vehicle (FCEV) mode based on vehicle-associated information input to the controller from an outside thereof.

10. A power control method for a fuel cell vehicle, the method comprising:
converting first electric power input to a converter via a first relay connected to a fuel cell stack into first demand electric power;
converting second electric power input to the converter via a second relay selectively connected to an external charger into second demand electric power; and
supplying the first demand electric power or the second demand electric power to a power consumption device.

11. The method according to claim 10, wherein the second relay turns off when the first relay turns on and the second relay turns on when the first relay turns off such that the first electric power and the second electric power are not simultaneously input to the converter.

12. The method according to claim 10, wherein converting the first electric power into the first demand electric power comprises turning on the first relay, turning off the second relay, and controlling the converter to convert the first electric power into the first demand electric power.

13. The method according to claim 10, wherein converting the second electric power into the second demand electric power comprises turning off the first relay, turning on the second relay, and controlling the converter to convert the second electric power into the second demand electric power.

14. The method according to claim 10, wherein the power consumption device comprises a high-voltage battery and a motor system, and wherein supplying the first demand electric power or the second demand electric power to the power consumption device comprises supplying the first demand electric power to the high-voltage battery and the motor system.

15. The method according to claim 10, wherein the power consumption device comprises a high-voltage battery, and wherein supplying the first demand electric power or the second demand electric power to the power consumption device comprises supplying the second demand electric power to the high-voltage battery.

16. The method according to claim 10, further comprising determining control for the first relay, the second relay, and the converter based on vehicle-associated information input to a controller from an outside thereof.

17. The method according to claim 16, wherein determining the control comprises turning on the first relay and turning off the second relay upon determining that a current state is a vehicle ignition on state and a current mode is a fuel cell electric vehicle (FCEV) mode.

18. The method according to claim 16, wherein determining the control comprises turning off the first relay and turning on the second relay upon determining that a current state is a vehicle ignition off state and a current mode is a fast charging mode.

19. The method according to claim 16, wherein determining the control comprises controlling the converter not to be driven upon determining that a current state is a vehicle ignition on state and a current mode is not a fuel cell electric vehicle (FCEV) mode.

20. A power control system for a fuel cell vehicle, the system comprising:
a power control apparatus comprising:
a first relay;
a second relay;
a converter connected to a first end of each of the first and second relays, wherein the converter is configured to convert first electric power input thereto via the first relay into first demand electric power, convert second electric power input thereto via the second relay into second demand electric power, and supply the first demand electric power or the second demand electric power to a power consumption device, the power consumption device comprising a high-voltage battery; and
a controller configured to control the first relay, the second relay, and the converter;
a fuel cell stack connected to a second end of the first relay; and
an external charger selectively connected to a second end of the second relay.
